(19) United States
(12) Patent Application Publication
(10) Pub. No.: US 2010/0023569 A1
(43) Pub. Date: Jan. 28, 2010

(54) METHOD FOR COMPUTERIZED ARITHMETIC OPERATIONS

(75) Inventors: James Shihfu Shiao, Stow, OH (US); Albert Shihyung Shiao, Stow, OH (US)

Correspondence Address: Emerson, Thomson & Bennett, LLC, 777 W. Market Street, Akron, OH, 44303, US

(73) Assignee: DAW SHIEN SCIENTIFIC RESEARCH & DEVELOPMENT, INC., Stow, OH (US)

(21) Appl. No.: 12/177,234

(22) Filed: Jul. 22, 2008

(51) Int. Cl. G06F 7/50; G06F 7/52

(52) U.S. Cl. 708/230; 708/523; 708/620

(57) ABSTRACT

A method of computing arithmetic operations more efficiently than the conventional Arithmetic Logic Unit (ALU) is disclosed. By encoding both operands from Binary Coded Decimal (BCD) codes (0000, to 1001) into decimal digits (0 to 9), inputting them in the GerTh's™ look-up tables, which are made of an array of AND gates, the invention finds the answer more efficiently. This method finds the result in fewer steps than a traditional ALU by reducing the repetitive calculation steps and logic gates required. And this new method makes the unsolvable computerized binary floating-point multiplications and divisions back to the solvable GerTh's computerized decimal digits' (0-9) elementary arithmetic operations.

### I. FIELD OF THE INVENTION

The present invention's operands are encoded from Binary Coded Decimal (BCD) codes (1001, 1000, 0111 . . . ) into Decimal Digit codes (9, 8, 7 . . . ) through encoders. The present invention relates generally to use of GerTh's™ arithmetic decimal single digit's (0-9) elementary look-up tables repetitively to the higher digits and finding those digits' answer one by one directly and efficiently, instead of carrying out the conventional calculation steps, which usually involves tedious binary number cycling. The GerTh's arithmetic decimal single digit's look-up tables mainly include the addition, subtraction, and multiplication look-up tables. The division process is made of the multiplication products list, comparisons and subtraction processes together in order to get its quotient and remainder. Other look-up table functions are the trigonometry, log, natural log (ln), exponential, etc. The requirements of using other functions' look-up tables require the combination of the first three main arithmetic look-up tables with them for finding/calculating their detailed extrapolating answers.

The CPU elements have look-up tables with both operands encoded from Binary Coded Decimal (BCD) codes into decimal digits (0 to 9) through encoders and inputting those operands in, so that the single digit's (0-9) elementary look-up tables will directly find the result for those digits and also the carry-out's (or borrow-in's depending on operations performed) digits for one-higher position repetitively to higher digits in a fast and direct way. The decimal digit counter has its specific power digit and will count its power's position in order to do the single digit power (0), ten's digit power (1), hundred's digit power (2), or even higher orders arithmetic operations. This new method reduces those tedious addition steps of the conventional binary multiplication process (and repetitive subtraction steps for the conventional division process) significantly, especially for floating-point binary multiplication and division. This method is much faster and more direct than conventional Arithmetic Logic Unit (ALU) binary floating-point numbers' multiplication and division. This powerful GerTh's single digit's elementary look-up process is able to make the tedious process of binary arithmetic calculations back to our original decimal digit operations and finding an answer even more direct and eliminating any unnecessary calculations and tedious steps of the logic.

### II. BACKGROUND OF THE INVENTION

In recent years, the conventional computer's CPU is made of instruction register, instruction decoder, controller, accumulator, Arithmetic Logic Unit (ALU), memory data register, output register, memory address register, and program counter, as shown in the prior art in FIG. (1).

The conventional CPU's accumulator and Arithmetic Logic Unit (ALU) are made of adder, accumulator, inverter (of 1's complement), of 2's complement, shift registers, complicated logic gates, etc. For the multiplication process, the conventional adder & accumulator will transfer this multiplication job to be added so many times, repetitively as the multiplier indicates. The most tedious process and difficult problems are the conventional binary floating-point's multiplication and division.

This new method resolves those conventional ALU's calculation problems. It shortens the logic of calculations, makes the finding/calculation faster by using the embedded single digit's elementary look-up tables (made of a few more than one hundred AND Gates array), and decimal digit counter for pointing operands and answer to that specified digit position.

This new method also uses the most significant bit of operands as their “SIGN BIT”. The “SIGN BIT” is “0” means positive. If the “SIGN BIT” is “1” means negative. For subtraction operation, if a positive minuend minus a negative subtrahend, that would be like two negatives (“−” and “−”) equal to one positive number. Therefore, that would change the minus negative's operation into a plus operation.

### III. SUMMARY OF THE INVENTION

The present invention utilizes different single digit's elementary look-up tables for substitution of the actual calculations steps. This look-up table is a device that can perform logic function and essentially does the (AND GATES) array logic. This new method utilizes CPU that have look-up tables with both OPERANDS encoded from Binary Coded Decimal (BCD) codes into decimal digits (0 to 9) and directing operands' digits into the look-up table as its inputs, in which will directly find the result for that specific digit position and also the carry-out's (or borrow-in's) digit for one-higher position. The decimal digit counter has its specific power digit and will count its power's position in order to do the single digit, ten's digit, hundred's digit, or even higher digit arithmetic operations. This new process reduces repetitive addition steps of the conventional multiplication process many times. These powerful look-up processes are making the findings/calculations even more direct and straightening the logic of calculations.

An advantage of the present invention is that it is more efficient to find the answer for a required digit and also the carry-out (or borrow-in) digit for that one-higher digit through the look-up tables of different operations. Four times binary bits (1001,1000) make one decimal digits (98). In macro binary look-up tables, the 400, 4,000, or even 4,000,000 times gates and registers make the same finding as the elementary single decimal digit's (0-9) look-up tables.

Another advantage of the present invention is the flexibility of the combination of different elementary look-up tables to pursue the Calculus operations. This new efficient arithmetic process can use both addition and multiplication look-up tables to do the Integration operation process. The similar procedure will combine both subtraction and division operation to do the Differentiation operation.

Another advantage of the present innovation is the faster process with only a few elementary look-up tables for each arithmetic operation. The addition operation only needs carry-in look-up table and addition look-up table. The subtraction operation only needs borrow-in look-up table and subtraction look-up table. The multiplication operation only has 2 multiplication look-up tables, addition look-up tables, and carry-in flip-flops (registers). The details and explanations of using those look-up tables are explained in the latter section.

Yet another advantage of the present invention is using its decimal digit counters as that specified digit's position indicator. It points to the present input and output digits to make sure that the look-up table finds the answer for that present decimal digit and the carry-out (or borrow-in) digit for the next one-higher digit, then repetitively increase to the higher digits.

The present invention is a digit counter cyclic process, whose effects can generate a specific power digit to feature that specific digit power with other related digits. It will have increment of itself as: digit counter=“0”; “digit counter”=“digit counter+1” . . . etc. Then, digit counter calibrates back and forth as in a nested “DO LOOPS” until it has gone through all the operation processes. The detailed explanations will be done in the latter section.

This new invention provides improvements over the conventional Arithmetic Logic Unit (ALU) for two aspects. The first aspect is using shorter processing time. The second aspect is using the fewer logic gate paths.

Yet another advantage is that this method permits the new CPU to have faster finding/calculation speeds and be more efficient at using each operation process.

The uses of these look-up tables are power-saving devices: for example: There are 10×10 lines and hundreds of gates in one elementary look-up table, and we only use 1/100 or 2/100 of their gates and lines at the same time. Therefore, arithmetic logic unit (ALU) will save a great amount of power that would conventionally be required to perform the operations. Additionally, the over-heating problems of CPUs will be less of an issue than it is in today's technology.

Another advantage of this invention is using (0-9) (+,−,×) (0-9) elementary look-up tables repetitively stepping into the higher digits. Therefore, the macro-scale look-up tables waste their numerous gates and hardware, and still raise the Binary floating-point numbers multiplication and division problems for unsolved. We encode operands from BCD codes to decimal digits (0 to 9), and do the elementary look-up tables' finding/calculating process repetitively to find those digits' answer. Then, we manipulate the decimal point position according to what the decimal digit's counter indicates, and make a final adjustment of decimal point position to get the final correct answer. According to the above adjustment, this method will have no problems for decimal floating-point multiplication and division problems. Four times binary bits (1001, 1000) make one decimal digits (98). In macro binary look-up tables, the 400, 4,000, or even 4,000,000 times gates and registers make the same finding as the elementary single decimal digit's (0-9) look-up tables. And still leave the Binary floating-point numbers multiplication and division problems for unsolved.

Another advantage of this invention for using (0-9) (+,−,×) (0-9) elementary decimal digit's look-up tables minimize the number of logic (to a hundred of AND GATES) required and the wires (and hard-wiring needed to connect the gates), which in turn saves money in manufacturing costs. In the prior art, large look up tables were required, and still could not resolve their binary floating-point numbers multiplication and division problems. This Decimal Digits' method solve those associated Binary operations' issues, and make the computerized unsolvable binary arithmetic operations back to our original solvable decimal digits' arithmetic operations.

### IV. BRIEF DESCRIPTION OF THE DRAWINGS

The invention may take physical forms (AND GATES) in certain parts (look-up tables) and arrangement of parts, embodiments of which will be described in detail in this specification and illustrated in the accompanying drawings which form a part hereof and wherein:

FIG. 1 is a schematic diagram of the conventional CPU's operation elements (The Prior Art).

FIG. 2 is a schematic diagram of the inventive look-up table process as the new arithmetic (AND) logic gates unit, decimal digit counter, and result buffer.

FIG. 3 is the addition look-up tables process with the two-operand (addend & adder) running through as the decimal digit counter indicates.

FIG. 3A is the addition look-up tables example.

FIG. 4 is the subtraction look-up tables process with the two-operand (minuend & subtrahend) running through as the decimal digit counter indicates.

FIG. 4A is the subtraction look-up tables example.

FIG. 5 is the multiplication look-up tables, using addition look-up tables and carry-in flip-flops processes with the two-operand (multiplicand & multiplier) running through by the decimal digit counters directed and iterating back and forth as in nested DO LOOPS;

FIG. 5A is the multiplication look-up tables example.

FIG. 6 is the division process, which combines the multiplication process with a products result list “divisor x (0, 1, through, 9)”, a comparator, and a subtraction look-up table with the two-operand from comparator running through by the decimal digit counters directed.

FIG. 6A is the division process example.

### V. DETAILED DESCRIPTION

Relevant definitions will now be listed:

Digit or Decimal Digit: any numeral from 0 to 9, especially when forming part of a number.

Operands: two numbers make an operation: Example: (addend & adder); (minuend & subtrahend); (multiplicand & multiplier); (dividend & divisor).

Digit position: number (987): “7” is occupied the single digit position.
“8” is occupied the ten's digit position.
“9” is occupied the hundred's digit position.

Decimal digit counter: counts, directs, and points to the single digit, ten's digit, hundred's digit, or even higher digit position for that specific digit operation.

Carry-in/or borrow-in flip flop: stores the carry-in/or borrow-in digit in register.

Carry-out digit: the digit is over-flow to be the carry-out digit. And two carry-out digits will go through an OR Gate and the final carry-out digit will be stored in the carry-in flip-flop (register).

Products table list: is a products result list, which is from divisor x (0, 1 to 9) products, are stored in the result buffer, and used for latter comparisons and subtraction operations.

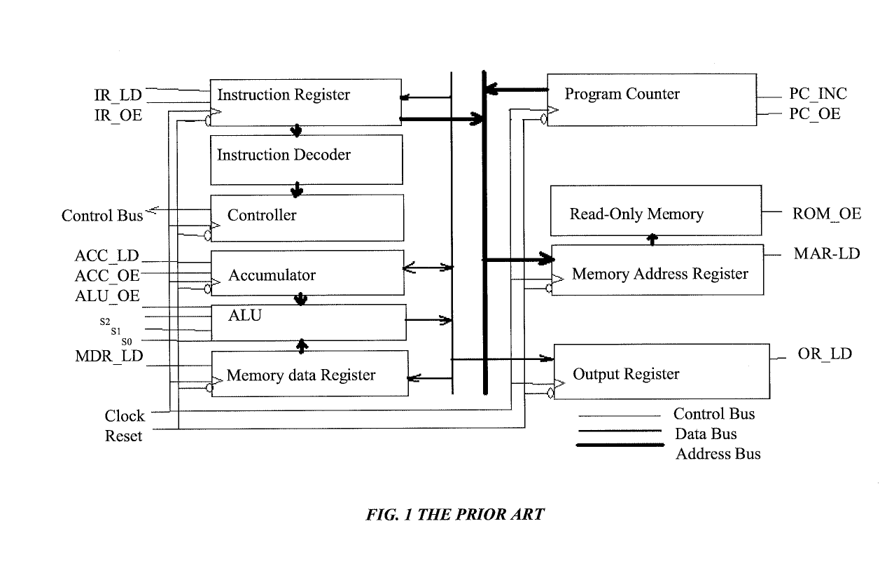

FIG. 1 is the prior art of the conventional computer CPU's elements.

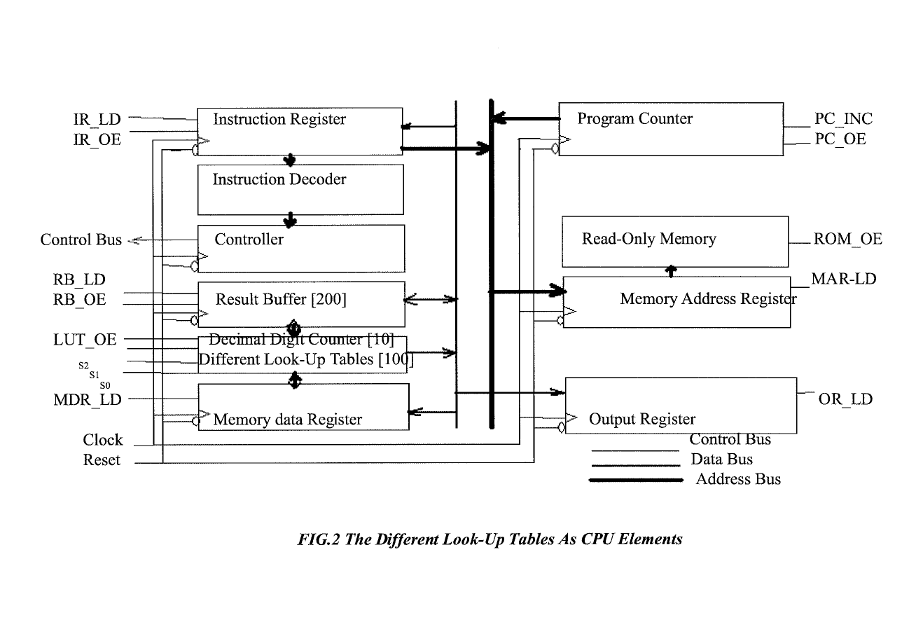

FIG. 2 is the present CPU's Arithmetic Logic Unit with multiple look-up tables for its arithmetic finding operations. The result buffer [200], different operations' look-up tables [100], and decimal digit counters [10] are the CPU's elements.

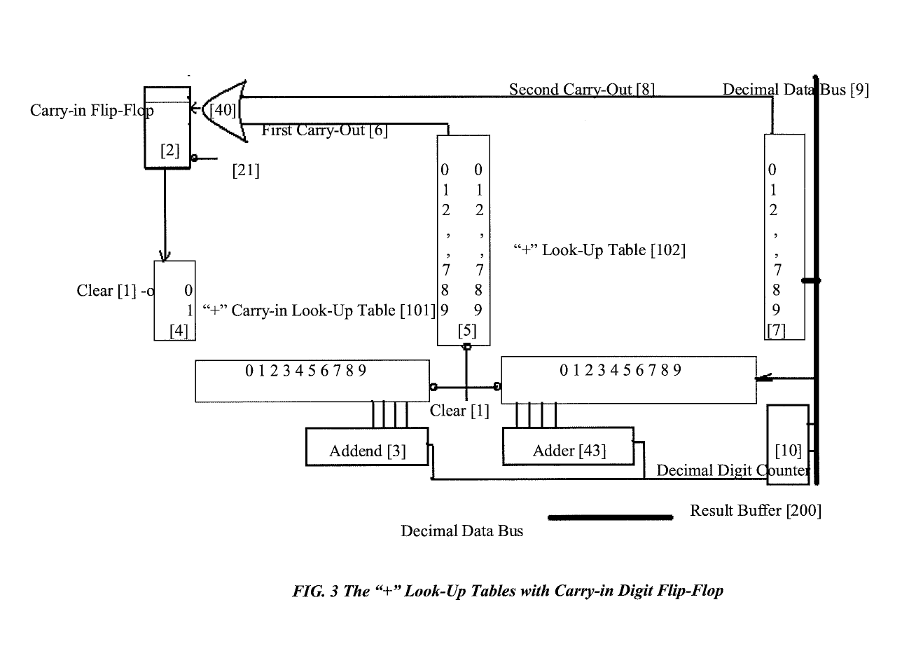

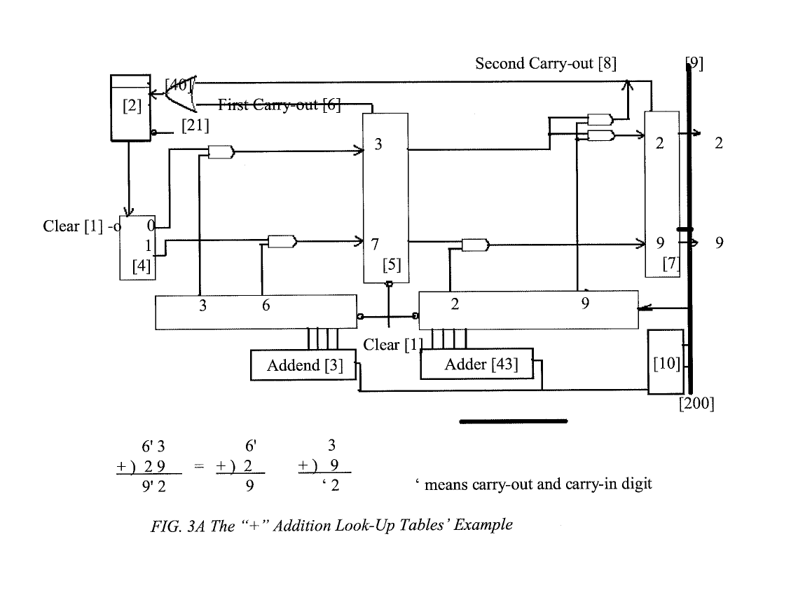

FIG. 3 is the method of operation for the addition look-up table: First, clear [1] all look-up tables' inputs, clear [21] the carry-in digit's flip-flop (register) [2] output; and zero the “decimal digit counter”=0[10].

1. The first square wave leading edge triggers the carry-in digit “0” [4] adding with the first digit of addend to store that digit (high) in storage flip-flops (registers) [5] (and) obtains the first carry-out digit “0” line low [6];

2. Then, the next square wave leading edge triggers that (first) digit of adder to be added to that (first) digit of addend to store that (first) digit answer (high) in storage flip-flops (registers) [7] and output the digit answer to the result buffer [200] through decimal data bus [9] as the decimal digit counter indicates. (And/or) obtains the second carry-out digit line (low/high) [8];

3. Those first and second carry-out digits have gone through an OR gate [40] and been processed to make the final carry-in digit (low/high) and stored in the carry-in flip-flop [2];

4. At the fourth step, clear [1] look-up tables' data inputs;

5. The next clock wave triggers the decimal digit counter increment “decimal digit counter”=“decimal digit counter+1” [10] to input one-higher digit data [3] into the carry-in look-up table [101] with the previous carry-in digit to store that (second) digit (high) in storage flip-flops (registers) [5] and obtains the first carry-out line (low/high) [6]. Then, clear [21] the previous carry-in digit flip-flop [2] output. Repeat the steps (2) to (5).

6. Do these processes continuously until the decimal digit counter [10] counts to the most significant decimal digit+1. Then get the whole addition answer to the result buffer [200], and this whole process is ready for the next operation.

FIG. 3A is the addition look-up table example where the [′] symbol means a carry-out digit 1. For example, when adding 63+29=9′2. It can be separated into single digit's addition as the decimal digit counter indicates=0: 3+(carry-in “0”)=3; 3(from the 63)+9(from the 29)=′ carry-out “1” and the number 2 is the first digit answer. These first and second carry-out digits have gone through an OR gate [40] and been processed to make the final carry-in digit “1” high and stored it in the carry-in flip-flop [2]. Then, clear the addition look-up tables' inputs and are ready for the next higher-digit's addition (and triggering the digit counter increment=digit counter+1). And for inputting the ten's digit number 6+′ carry-in digit 1=7; clear the previous carry-in flip-flop [2]. And 7+2(from 29)=9 is the ten's digit answer. Therefore, the answer 92 is stored in the result buffer [200] as the digit counter indicates. And whole process is ready for the next operation.

$$\begin{matrix} & 63 \\ + ) & 29 \\ & 9 \text{’} 2\end{matrix}$$

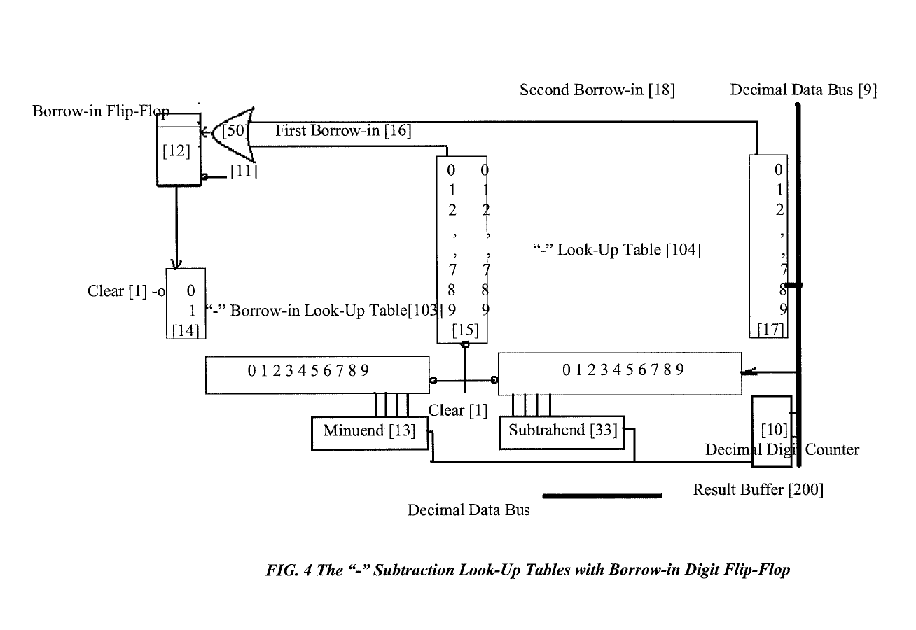

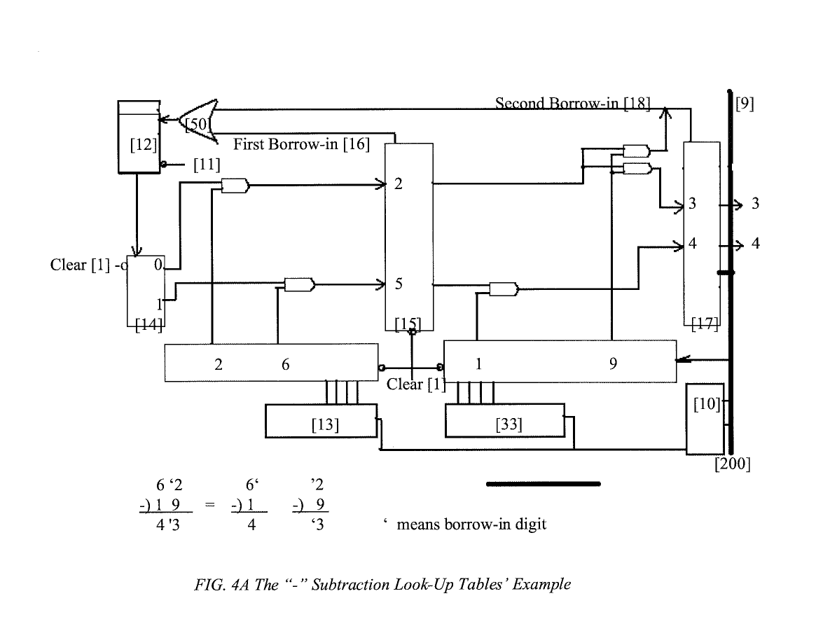

FIG. 4 is the “−” subtraction's look-up table:

First, clear [1] all look-up tables' inputs, clear [11] the borrow-in digit's flip-flop [12] output, and zero the decimal digit counter=0[10].

Second, compare minuend [13] with subtrahend [33], and make sure the minuend is greater or equal to the subtrahend. If not, switch the minuend with the subtrahend, then do the subtraction as normal as the following to get the temporary answer. At last, put the negative sign “−” in front of this temporary answer to be adjusted to the final answer, and stored it in the result buffer [200] through decimal data bus [9].

1. The first square wave leading edge triggers the borrow-in digit “0” [14] is subtracted from the first digit of minuend [13] to store that (first) digit (high) in registers [15] (and) obtains the borrow-in digit line low “0” [16] through the borrow-in look-up table [103];

2. Then, the next square wave leading edge triggers that (first) digit of subtrahend [33] to be subtracted from that (first) digit of minuend [13] to store that (first) digit answer (high) in registers [17] through the subtraction look-up table [104]. And output that (first) digit answer through decimal data bus [9] to the result buffer [200] as the decimal digit counter [10] indicates. (And/or) obtains the second borrow-in line (low/high) [18];

3. These first and second borrow-in digits have gone through an OR gate [50] and been processed to make the final borrow-in digit (low/high) and stored in the borrow-in flip-flop [12];

4. At the fourth step, clear [1] look-up tables' data inputs;

5. The next clock wave triggers the “decimal digit counter increment”=“decimal digit counter+1” [10] to input one-higher digit data into the borrow-in look-up table [103] with the previous borrow-in digit to store that specified (ten's) digit (high) in registers [15] and obtains the first borrow-in digit line (low/high) [16]. Then, clear [11] the previous borrow-in digit flip-flop [12] output. Repeat the steps (2) to (5);

6. Do these processes continuously until the decimal digit counter [10] counts to the most significant decimal digit of minuend;

7. This final step is for the minus sign (−) adjustments, for which the minuend and subtrahend have been switched in order to get the final correct answer. Then, stored the correct answer in the result buffer [200] through the decimal data bus [9], and the whole process is ready for the next operation.

FIG. 4A is the subtraction look-up table example; ‘means borrow-in digit. 6’2−19=43. It can be separated into single digit's subtraction as the digit counter indicates that digit counter position=0: 2−(borrow-in “0”)=2 and obtains the borrow-in digit “0”; ‘2−9=the second’ borrow-in digit “1” and the number 3 is the first digit answer. And the first and second borrow-in digits are gone through an OR gate [50] and stored the final borrow-in digit in the borrow-in flip flop [12]. Then, clear [1] the subtraction look-up tables' inputs (i.e. decimal digit counter increment=decimal digit counter+1). And for the ten's digit 6−‘borrow-in digit 1=5 and obtains the first borrow-in digit “0”; and clear the previous borrow-in flip-flop's output. and 5−1=4 is the answer for the ten's digit. Therefore, the answer 43 is stored in the result buffer [200] as the digit counter [10] indicates, and the whole process is ready for the next operation.

$$\begin{matrix} & 6 \text{’} 2 \\ - ) & 19 \\ & 43\end{matrix}$$

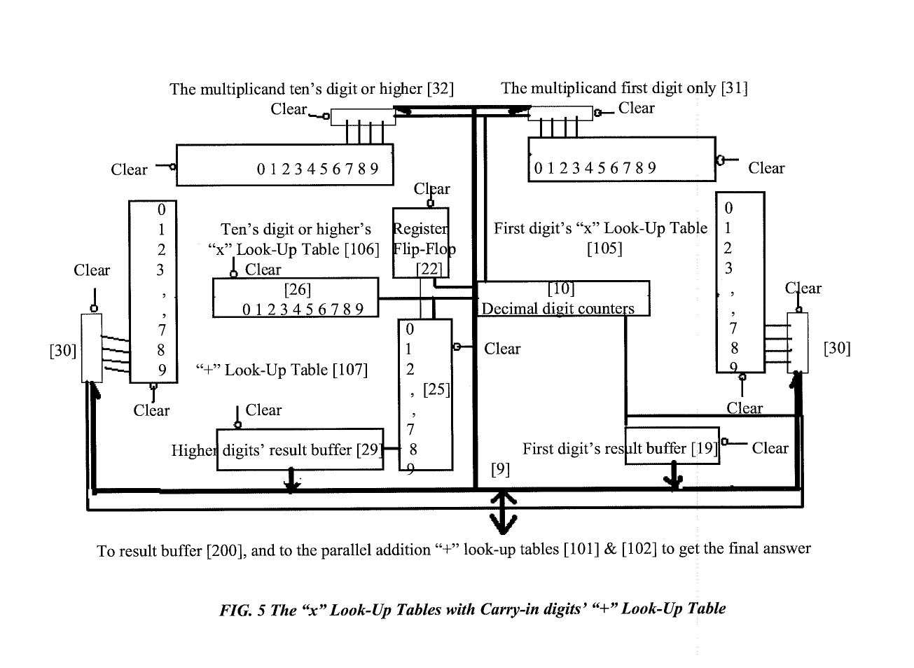

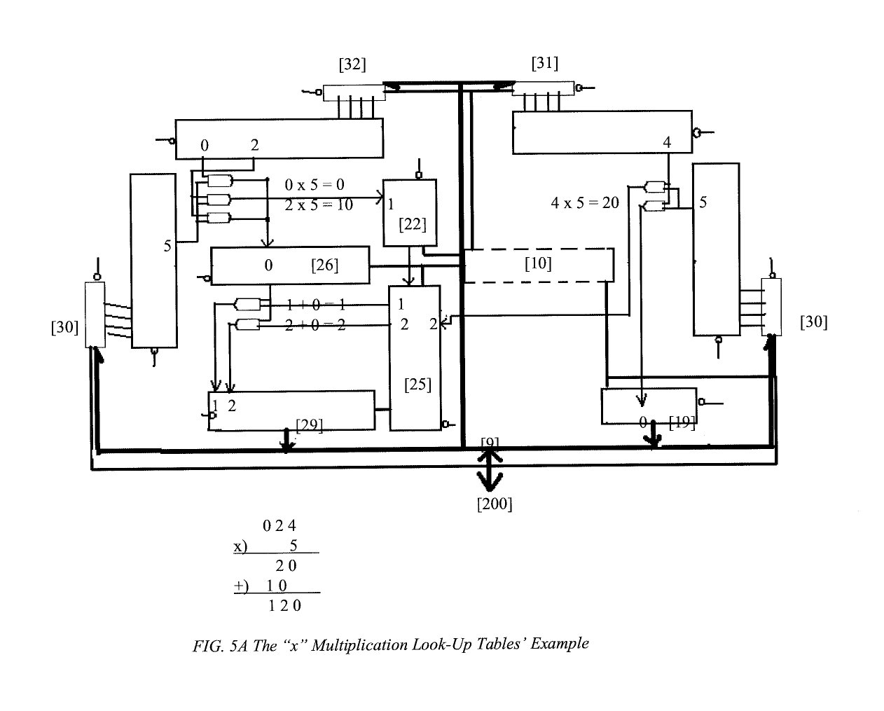

FIG. 5 is the multiplication's look-up tables [105] [106] with addition look-up tables [107]:
First, clear all look-up tables' inputs, carry-out digits' flip-flops [22], and
“decimal digit counter”=0; and
“multiplicand's decimal digit counter”=0;
“multiplier's decimal digit counter”=0; and
N=0;

1. The first square wave leading edge triggers the first single digit of multiplicand [31] times with the first single (or specified) digit of the multiplier [30] to store that first single (or specified) digit answer (0-9) (high) in a first result registers [19], and store the first carry-in digit (0 to 8) high in registers [25] as an input of the addition look-up table);

2. Then, the next square wave leading edge triggers the multiplicand's digit counter increment and also the result digit counter+1 higher [10]:
(decimal digit counter=decimal digit counter+1).
“multiplicand's decimal digit counter”=“multiplicand's decimal digit counter+1”
“multiplier's decimal digit counter” keeps the same multiplier's digit.

3. The next digit of the multiplicand [32] times with the same multiplier's digit [30], which may store that digit (0-9) (high) in registers [26], and store the second carry-out digit (0 to 8) (high) in the carry-in flip-flops (registers) [22]. Combine the previous (first) carry-in digit in registers [25] with that digit (0-9) in registers [26] into addition look-up tables [107]. That stored result digit in result digit registers [29] is the answer digit, which is indicated by the decimal digit counter [10]. (And/or) obtains the third carry-out digit (low/high);

4. Clear the first multiplication look-up table's [105] inputs and the addition look-up tables' [107] inputs;

5. Move the second carry-out digit (0 to 8) and third carry-out digit (0-1) from carry-in flip-flops [22] into the addition look-up table and stored as its new carry-in input in registers [25];

6. Clear the second multiplication look-up table's [106] inputs and the previous carry-out flip-flops (registers) [22] outputs;

7. Repeat steps (2) to (7) until it's done with the most significant digit+1 of the multiplicand;

8. Add this product layer to the previous product layer (the very first product layer is 0.) from result buffer [200] together through another parallel addition processes [101] & [102] until the addition answer is got, and re-stored in the result buffer [200];

Re-iterate the digit counter [10] as in nested DO LOOPS:
N=N+1;
“decimal digit counter”=“N”;
“multiplicand's decimal digit counter”=“0”;
“multiplier's decimal digit counter”=“N”;

9. Repeat steps (1) to (8) until the most significant digit of the multiplier has been processed totally, and the final answer is got and re-stored in the result buffer [200]. Then, this whole process is ready for the next operation.

FIG. 5A is the “x” multiplication with addition look-up tables example:

024×5=120
First, clear all look-up tables inputs, carry-out digits flip-flops [22], and zero the
“decimal digit counter”=0; and
“multiplicand's decimal digit counter”=0;
“multiplier's decimal digit counter”=0; and
N=0;

1. The first square wave leading edge triggers the first single multiplicand's digit number 4[31] with the (first single or) specified digit number 5 of the multiplier [30] to get that first digit answer 0 stored in the first result registers [19] (and) store the first carry-out number 2 in registers [25] as an input;

2. Then, the next square wave leading edge triggers the multiplicand's digit counter increment and the result digit counter+1 higher [10]:
(decimal digit counter=decimal digit counter+1).
“multiplicand's decimal digit counter”=“multiplicand's decimal digit counter+1”

3. The next digit number 2 of the multiplicand [32] times with the same multiplier's digit number 5 [30], which may store that digit number 0 in registers [26] (and) obtains the second carry-out digit number 1 stored in flip-flops [22]. By combining that digit number 0 [26] with the previous (first) carry-in line number 2 [25] into addition look-up tables [107], the output of the summation result digit number 2 [29] is the second digit answer, which is indicated by decimal digit counter [10], and the third carry-out digit 0 line high is stored in the carry-in flip-flops;

4. Clear the first multiplication look-up table's [105] and the addition look-up tables' [107] inputs;

5. Move the previous (second and third) carry-out digit numbers 1 and 0 from the carry-out flip-flops [22] into the addition look-up table as its new input number 1 [25];

6. Clear the second multiplication look-up table's [106] inputs and the previous carry-out flip-flops' [22] outputs;

7. Repeat steps (2) to (7) until it's done with the most significant digit+1 of the multiplicand's “0”; and we get the answer

$$\underline{024 \times 5 = 120}$$

$$\begin{matrix} & 024 \\ \times ) & 55 \\ & 120 \\ + ) & 1200 \\ & 1320\end{matrix}$$

8. Add this product layer with the previous product layer (the very first product layer is 0.) from result buffer [200], together through another parallel addition processes [101] & [102] until the addition answer is got and re-stored in the result buffer [200];
Re-iterate the digit counter [10] as:
N=N+1;
“decimal digit counter”=“N”;
“multiplicand's decimal digit counter”=“0”;
“multiplier's decimal digit counter”=“N”;

9. Repeat steps (1) to (8) until the most significant digit of the multiplier has been completely processed. The final answer is got and re-stored in the result buffer. Then, this whole process is ready for the next operation.

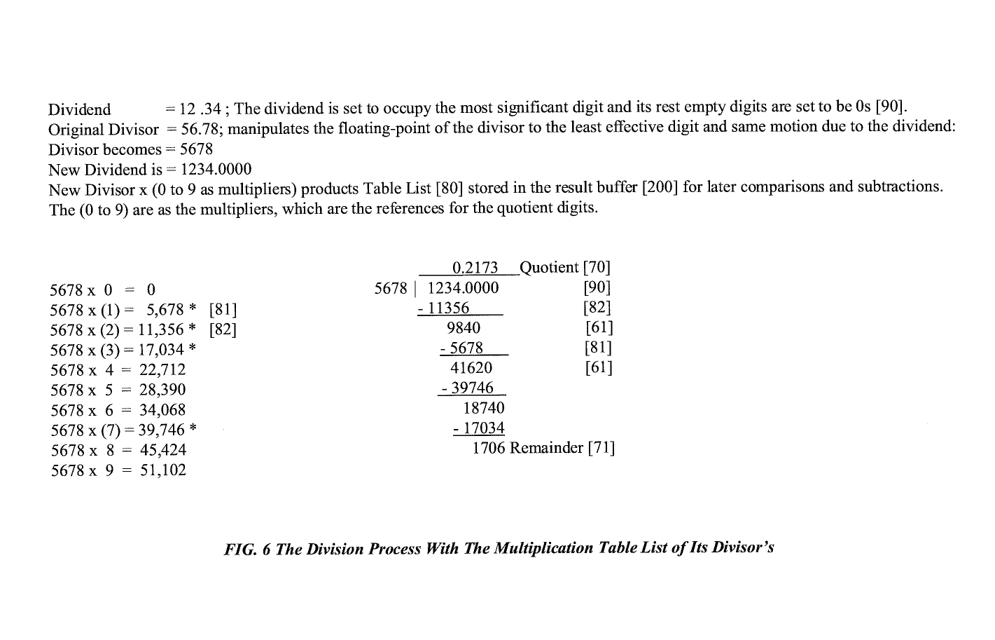

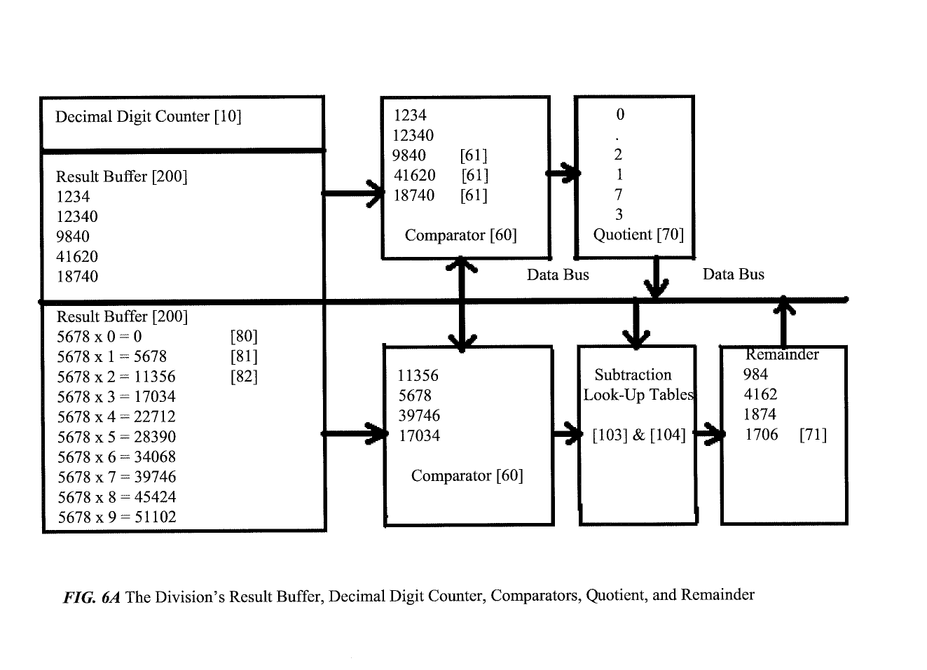

FIG. 6 is the division process, which combines the multiplication's look-up table products list [80], comparison process, and the subtraction process.

First, compare the dividend with the divisor:
If the dividend=0, the quotient=0 and the remainder=0:
If the divisor=0, there is a violation, and can not get the answer:

1. First, make the divisor's decimal points to be floating to its least significant digit (same floating-point digit actions are due to the dividend), from which they are easier to be compared and accurately to get the suitable decimal point's position;

2. Make this new floated divisor times with (0, 1; 2; through, 9) produced products table list [80] in the result buffer [200] for their later comparison with the new dividend/remainder. Their multipliers (0 to 9) are the references of being a quotient digits [70] and the subtraction process gets the remainders [71];

3. Make the dividend started from the highest significant digit position with its suitable decimal point's position (due to the floating-point numbers), and make its rest empty digits being 0 [90];

4. If the dividend is smaller than the divisor, write the quotient to be “0.”;

5. Move the decimal digit counter to one lower position (decrement); “decimal digit counter”=“decimal digit counter−1”; and add one “0” after the dividend. Until stops at where “decimal digit counter” decreases to “0”, or the answer and the remainder are got.

6. Compare the new dividend/remainder [61] with the same divisor. If the new dividend/remainder [61] is still smaller than the divisor, add one more “0” after the decimal point to the quotient digit as “0.0”. Repeat the steps (5) to (6) until the dividend is greater than the divisor. Jump step to (7).

7. Compare the new dividend/remainder [61] with the divisor's (0 to 9 as multipliers) products list until finding the most closest answer, which is smaller than or equal to the new dividend/remainder [61]. Write that multiplier (one of 1-9) as its following quotient's digit [70] as the decimal digit counter indicates, and minus that product number from the new dividend/remainder to get the new remainder [61]. Repeat steps (5) to (7) until all digits are used or the answer and the remainder are found.

8. These final answers are got and re-stored in the result buffer [200], separately. Then, this whole process is ready for the next operation.

FIG. 6A is the division process example. The dividend is 12.34 and the divisor is 56.78. Make the floating-point of the divisor 56.78 to its least significant digit as 5678. and the same motion due to the dividend 12.34 to be 1234.; This division process combines the multiplication products table list [80], the comparators [60], and the parallel subtraction process [103] [104]. The new dividend/remainder stored in the result buffer [200], and the products table list is also stored in the result buffer [200], separately.

1. Compare the new dividend/remainder 1234. with the new divisor 5678. in the comparators [60]. The divisor is greater than the dividend, then write “0.” with decimal point after it to be the quotient's highest digit.

2. Make a decrement for the decimal digit counter=decimal digit counter−1, and add one more zero to the end of the old dividend/remainder.

3. After that adding, the new dividend 12340 is compared with the products table list, and the closest one 11356 is smaller than 12340. Write that list's multiplier number 2 after decimal point 0. as its quotient next digit, and do the parallel subtraction work through the subtraction look-up tables [103] [104]. And the remainder is 984. Add one more zero to the end of the old dividend/remainder 984 to become 9840. Iterates steps (1)-(3) until gets the final quotient and remainder.

These look-up tables are power-saving devices: for example 6+1=7; or 6+9='5; ' means the carry-out digit 1. Normally, there are 10×10 lines along with the same number of gates. In this embodiment, the process only uses 1/100 or 2/100 of the gates and lines at the same time. Therefore, the new disclosed arithmetic logic unit (ALU) will conserve energy, and the issues regarding over-heating problems of the current CPU's will be resolved.

The foregoing descriptions of specific innovations of the present invention are presented for purposes of illustration and applications. They are not intended to be exhaustive or to limit the invention to the precise forms disclosed, and obviously many modifications and variations are possible in light of the above disclosure. It is intended that the scope of the invention is defined by the claims appended hereto and their equivalents. Therefore, the scope of the invention is to be limited only by the following claims.

Having thus described the invention, it is now claimed:

1. A method for computerized arithmetic operations comprising:
(a) receiving all digits from the first addend and at least a first digit from a first adder wherein the first addend and first adder each have at least one digit, and a decimal digit counter equals zero;
(b) triggering a digit position corresponding to the first digit from the first addend to an excited state in a first digit encoder and triggering a digit position corresponding to the first digit from a first adder to an excited state in a second digit encoder;
(c) adding a zero from a carry-in flip-flop to a first addend and moving the first digit of the first addend to a storage flip flop and obtaining a first carry-out digit;
(d) adding the first digit of the first addend to the first digit of the adder;
(e) producing a result digit and a second carry-out digit;
(f) moving the result digit to a result buffer through a decimal data bus and moving the first and second carry-out digits to an OR gate;
(g) storing a final carry-out digit from the output of the OR gate into the carry-in flip-flop;
(h) clearing the inputs of look-up tables; and,
(i) triggering the decimal digit counter to increase by one;

2. The method of claim 1, if the first addend and/or the first adder are greater than 9, a second result digit from the first addend and the first adder will be calculated iteratively through the look-up tables.

3. The method of claim 1, proceeding after step (i) comprising:
(j) receiving a second digit from the first adder wherein the first adder has at least two digits and the decimal digit counter equals one;
(k) triggering a digit position corresponding to the second digit of the first addend to an excited state in the first digit encoder and triggering a digit position corresponding to the second digit from the first adder to an excited state in a second digit encoder;
(l) adding the final carry-out digit from the carry-in flip-flop to the second digit of the first addend and moving a temporary result of the second digit into the storage flip flop and obtaining a third carry-out digit;
(m) clearing the output of the carry-in flip-flop.
(n) adding the second digit of the temporary result of the first addend to the second digit of the first adder;
(o) producing a second result digit and a fourth carry-out digit;
(p) moving the second result digit through the decimal data bus to the result buffer;
(q) moving the third and fourth carry-out digits to the OR gate;
(r) storing a second final carry-out digit from the output of OR gate into the carry-in flip-flop;
(s) clearing the inputs of the look-up tables;
(t) triggering the decimal digit counter to increase by one; and,
if the sum of the first addend and second adder is less than 100 or greater than 9, an answer consists of the first and second result digits.

4. The method of claim 3, proceeding after step (t) comprising:
(u) activating a third digit of the first addend to the excited state in the first digit encoder, and activating a third digit of the first adder in the second digit encoder;
(v) adding the second final carry-out digit from the carry-in flip-flop to the third digit of the first addend and moving the third temporary result digit of the first addend to a storage flip flop and obtaining a fifth carry-out digit;
(w) clearing the output of the carry-in flip-flop.
(x) adding the third temporary result digit of addend to the third digit of adder;
(y) producing a third result digit and a sixth carry-out digit;
(z) moving the third result digit through the decimal data bus to the result buffer and moving the fifth and sixth carry-out digits to the OR gate;
(aa) storing a third final carry-out digit from the output of the OR gate into the carry-in flip-flop;
(bb) clearing the inputs of look-up tables;
(cc) triggering the decimal digit counter to increase by one; and,
if the sum of the first addend and adder is less than 1000 or greater than 99, an answer consists of the first, second, and third result digits.

5. A method for computerized arithmetic operations comprising:
(a) receiving a minuend and a subtrahend wherein the minuend and subtrahend each have at least one digit;
(b) comparing the minuend with the subtrahend to verify that the minuend is greater than or equal to the subtrahend, if the subtrahend is greater than the minuend, the subtrahend swap positions with the minuend;
(c) triggering a digit position corresponding to the first digit of the minuend to an excited state in a first digit encoder and triggering a digit position corresponding to the first digit of the subtrahend to an excited state in a second digit encoder and a decimal digit counter equals zero;
(d) subtracting a borrow-in digit zero from a borrow-in flip-flop from the first digit of the minuend and moving the first digit of the minuend to a storage flip flop and obtaining a first borrow-in digit;
(e) subtracting the first digit of the subtrahend from the first digit of the minuend;
(f) producing a result digit and a second borrow-in digit;
(g) moving the result digit to a result buffer through the decimal data bus;
(h) moving the first and second borrow-in digits to an OR gate;
(i) storing a first final borrow-in digit from the output of the OR gate into the borrow-in flip-flop;
(j) clearing the inputs of look-up tables;
(k) triggering the decimal digit counter to increase by one; and,
(l) wherein the process of steps (a) through (k) can be repeated iteratively for finding/calculating more result digits.

6. The method of claim 5, proceeding after step (k) comprising:
(m) triggering a digit position corresponding to the second minuend digit to an excited state in the first digit encoder and triggering a digit position corresponding to the second subtrahend digit to an excited state in the second digit encoder;
(n) subtracting the final borrow-in digit of the borrow-in flip-flop from the second digit of the minuend and moving a second temporary result digit of the subtraction to the storage flip flop and obtaining a third borrow-in digit;
(o) clearing the output of the borrow-in flip-flop and subtracting the second digit of the subtrahend from the second temporary result digit of minuend;
(p) producing a second result digit and a fourth borrow-in digit;
(q) moving the second result digit to the result buffer through a decimal data bus and moving the third and fourth borrow-in digits to the OR gate;
(r) storing a second final borrow-in digit from the output of the OR gate into the borrow-in flip-flop;
(s) clearing the inputs of look-up tables;
(t) triggering the decimal digit counter to increase by one;
(u) putting a minus sign before an answer, if the minuend and subtrahend have been swapped around; and,
if the difference of the minuend and subtrahend is less than 100 or greater than 9, an answer consists of the first and second result digits, and putting the minus sign before the answer if the minuend and the subtrahend have been swapped around.

7. A method for computerized arithmetic operations comprising:
(a) receiving all digits from a multiplicand and a first digit from a multiplier wherein the multiplicand and the multiplier each have at least one digit and a result digit counter equals zero;
(b) triggering a digit position corresponding to the first digit of the multiplicand to an excited state in a first digit encoder and triggering a digit position corresponding to the first digit of the multiplier to an excited state in a second and a third digit encoders;
(c) multiplying the first digit of the multiplicand from the first digit encoder with the first digit of the multiplier from the second digit encoder at a first multiplication look-up table;
(d) producing a first result digit and a first carry-out digit;
(e) receiving the first result digit to a result buffer and triggering a multiplicand digit counter and the result digit counter to increase by one;
(f) activating a second digit of the multiplicand to the excited state in the fourth digit encoder and multiplying a second digit of the multiplicand from a fourth digit encoder with the first digit of the multiplier from the third digit encoder at a second multiplication look-up table;
(g) producing a second digit temporary result and a second carry-out digit;
(h) adding the second digit temporary result with the first carry-out digit at an addition look-up table to obtain a second result digit and a third carry-out digit;
(i) receiving the second result digit in a result buffer and triggering a multiplicand digit counter and the result digit counter to increase by one;
(j) clearing the inputs of the multiplication look-up tables and the inputs of the addition look-up table;
(k) combining the second and third carry-out digits to obtain a first final carry-out digit as a new input to the addition look-up table; and,
if the product of the multiplicand and multiplier is less than 100 or greater than 9, an answer consists of the first and second result digits.

8. The method of claim 7, proceeding after step (k) comprising:
(l) a result digit counter equals two;
(m) triggering a digit position corresponding to the third digit of the multiplicand to an excited state at the fourth digit encoder;
(n) multiplying the third digit of the multiplicand with the first digit of the multiplier through the second multiplication look-up table;
(o) producing a third digit temporary result and a fourth carry-out digit;
(p) adding the third digit temporary result with the second and third carry-out digits as inputs of the addition look-up table;
(q) producing a third result digit and a fifth carry-out digit; and,
(r) receiving the third result digit in the result buffer and triggering a multiplicand digit counter and the result digit counter to increase by one;
(s) clearing the inputs of the second multiplication look-up table and the inputs of the addition look-up table;
(t) combining the fourth and fifth carry-out digits to obtain a second final carry-out digit as a subsequent input of the addition look-up table.

9. A method for computerized arithmetic operations comprising:
(a) receiving a divisor and a dividend, wherein a decimal digit counter position of the dividend starts from a most significant digit;
(b) comparing the dividend to the divisor to verify that the divisor does not equal zero and moving a decimal point position of the divisor to the right of the least significant digit and moving a decimal point position of the dividend the same number of digits;
(c) multiplying the repositioned divisor by one to nine and storing a divisor products result in a result buffer;
(d) moving the position of the dividend to increase the dividend by a factor of 10 if the repositioned dividend is smaller than the divisor and writing a zero with a decimal point to the result as a quotient digit, and the decimal digit counter is decreased by one;
(e) repeating step (d) until the repositioned dividend is greater than the divisor;
(f) selecting the products result that is closest to the repositioned dividend, and is less than or equal to the repositioned dividend;
(g) choosing a multiplier of that selected product result to be one of the quotient digits;
(h) subtracting that selected divisor product result from the repositioned dividend to create a remainder;
(i) multiplying the remainder by a factor of 10 to obtain a subsequent dividend;
(j) repeating step (d), (e), (f), (g), (h), and (i) until the remainder is zero or a predetermined decimal place is reached.

10. The method of claim 9, wherein step (c) further comprises:
(a) receiving all digits from a multiplicand and at least a first digit from a multiplier wherein the multiplicand and the multiplier each have at least one digit and a result digit counter equals zero;
(b) triggering a digit position corresponding to the first digit of the multiplicand to an excited state in a first digit encoder and triggering a digit position corresponding to the first digit of the multiplier to an excited state in a second and a third digit encoders;
(c) multiplying the first digit of the multiplicand from the first digit encoder with the first digit of the multiplier from the second digit encoder at a first multiplication look-up table;
(d) producing a first result digit and a first carry-out digit;
(e) receiving the first result digit to a result buffer and triggering a multiplicand digit counter and the result digit counter to increase by one;
(f) multiplying a second digit of the multiplicand from a fourth digit encoder with the first digit of the multiplier from the third digit encoder at a second multiplication look-up table;
(g) producing a second digit temporary result and a second carry-out digit;
(h) adding the second digit temporary result with the first carry-out digit at an addition look-up table to obtain a second result digit and a third carry-out digit;
(i) receiving the second result digit to a result buffer and triggering a multiplicand digit counter and the result digit counter to increase by one;
(j) clearing the inputs of the multiplication look-up tables and the inputs of the addition look-up table;
(k) combining the second and third carry-out digits to obtain a first final carry-out digit as a new input to the addition look-up table; and,
if the product of the multiplicand and multiplier is less than 100 or greater than 9, an answer consists of the first and second result digits.

11. The method of claim 9, wherein step (h) further comprises:
(a) receiving a minuend and a subtrahend wherein the minuend and subtrahend each have at least one digit;
(b) comparing the minuend with the subtrahend to verify that the minuend is greater than or equal to the subtrahend, if the subtrahend is greater than the minuend, the subtrahend swap positions with the minuend;
(c) triggering a digit position corresponding to the first digit of the minuend to an excited state in a first digit encoder and triggering a digit position corresponding to the first digit of the subtrahend to an excited state in a second digit encoder and a decimal digit counter equals zero;
(d) subtracting a borrow-in digit zero from a borrow-in flip-flop from the first digit of the minuend and moving the first digit of the minuend to a storage flip flop and obtaining a first borrow-in digit;
(e) subtracting the first digit of the subtrahend from the first digit of the minuend;
(f) producing a result digit and a second borrow-in digit;
(g) moving the result digit to a result buffer through the decimal data bus;
(h) moving the first and second borrow-in digits to an OR gate;
(i) storing a first final borrow-in digit from the output of the OR gate into the borrow-in flip-flop;
(j) clearing the inputs of look-up tables;
(k) triggering the decimal digit counter to increase by one;
(l) wherein the process of steps (a) through (k) can be repeated iteratively for finding/calculating more result digits;
